(19) United States
(12) Patent Application Publication
(10) Pub. No.: US 2007/0277059 A1
(43) Pub. Date: Nov. 29, 2007

(54) Storage device, control device, and error reporting method

(75) Inventor: Kenji Ogawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/525,001

(22) Filed: Sep. 21, 2006

(30) Foreign Application Priority Data
May 24, 2006 (JP) 2006-144670

(51) Int. Cl. G06F 11/00

(52) U.S. Cl. 714/54

(57) ABSTRACT

A storage device performs a reading process or a writing process based on a command received from an upper-level device, and when an error occurs in the reading process or the writing process, generates a predetermined sense according to a result of a retry, and reports the predetermined sense to the upper-level device. A time measuring unit measures a remedying time that is required to remedy the error in execution of the command by a hidden retry that is executed as a sort of the retry. A time determining unit determines whether the remedying time measured by the time measuring unit exceeds a predetermined time threshold.

### BACKGROUND OF THE INVENTION

1. Field of the Invention

The present invention relates to a storage device, a control device, and an error reporting method for performing a reading process or a writing process based on a command received from an upper-level device, and when an error occurs in the reading process or the writing process, generating a predetermined sense according to a result of a retry, and reporting the predetermined sense to the upper-level device.

2. Description of the Related Art

In a conventional technology called sense reporting, if an error occurs in a reading process or a writing process that is executed according to a command from a host that is an upper-level device, generally a retry of the reading process or the writing process is carried out as a recovery process, and a result of the retry is reported as a sense from a magnetic disk device to the host so that the host recognizes a risk (for example, performance deterioration etc.) in sectors that are within the scope of the command (see, for example, Japanese Patent Application Laid-Open No. H10-83635).

The conventional technology is briefly explained. In the retry, which is the recovery process, a retry of comparatively simple content is carried out a few times and is called a hidden retry, and if the error is not remedied by the hidden retry, a retry of a complex content is immediately carried out several times and is called a normal retry. Only the result of the normal retry is reported as a sense (for example, a sense to the effect that the error is remedied by the normal retry, a sense to the effect that further retry is carried out etc.) to the host.

However, an unrecoverable error occurs in the aforementioned conventional technology.

In other words, in the conventional technology, if the error that occurs in the reading process or the writing process is remedied by the hidden retry, because the result of the hidden retry is not reported to the host as a sense, the host is not able to recognize a performance degradation in a group of sectors that are actually causing frequent retries, and sectors that can cause an unrecoverable error later are likely to be overlooked.

### SUMMARY OF THE INVENTION

It is an object of the present invention to at least partially solve the problems in the conventional technology.

A storage device according to one aspect of the present invention performs a reading process or a writing process based on a command received from an upper-level device, and when an error occurs in the reading process or the writing process, generates a predetermined sense according to a result of a retry, and reports the predetermined sense to the upper-level device. The storage device includes a time measuring unit that measures a remedying time that is required to remedy the error in execution of the command by a hidden retry that is executed as a sort of the retry; and a time determining unit that determines whether the remedying time measured by the time measuring unit exceeds a predetermined time threshold.

A control device according to another aspect of the present invention is for a storage device that performs a reading process or a writing process based on a command received from an upper-level device, and when an error occurs in the reading process or the writing process, generates a predetermined sense according to a result of a retry, and reports the predetermined sense to the upper-level device. The control device includes a time measuring unit that measures a remedying time that is required to remedy the error in execution of the command by a hidden retry that is executed as a sort of the retry; and a time determining unit that determines whether the remedying time measured by the time measuring unit exceeds a predetermined time threshold.

An error reporting method according to still another aspect of the present invention is for a storage device that performs a reading process or a writing process based on a command received from an upper-level device, and when an error occurs in the reading process or the writing process, generates a predetermined sense according to a result of a retry, and reports the predetermined sense to the upper-level device. The error reporting method includes measuring a remedying time that is required to remedy the error in execution of the command by a hidden retry that is executed as a sort of the retry; and determining whether the remedying time measured by the time measuring unit exceeds a predetermined time threshold.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an outline and a salient feature of a magnetic disk device according to a first embodiment of the present invention;

FIG. 2 is a block diagram of a structure of the magnetic disk device according to the first embodiment;

FIG. 3 is a schematic of a setting example of a time threshold;

FIG. 4 is a flowchart of a sequence of a process of the magnetic disk device according to the first embodiment;

FIG. 5 is the flowchart of the sequence of the process of the magnetic disk device according to the first embodiment; and

FIG. 6 is a schematic of a setting example of the time threshold.

### DETAILED DESCRIPTION OF THE PREFERRED EMBODIMENTS

Exemplary embodiments of the present invention are explained below in detail with reference to the accompanying drawings. A magnetic disk device is explained below in a first embodiment of the present invention as an example of the storage device according to the present invention, followed by other embodiments of the present invention.

An outline, a salient feature, a structure, and a process of the magnetic disk device according to the first embodiment are sequentially explained, and effects due to the first embodiment are explained in the end.

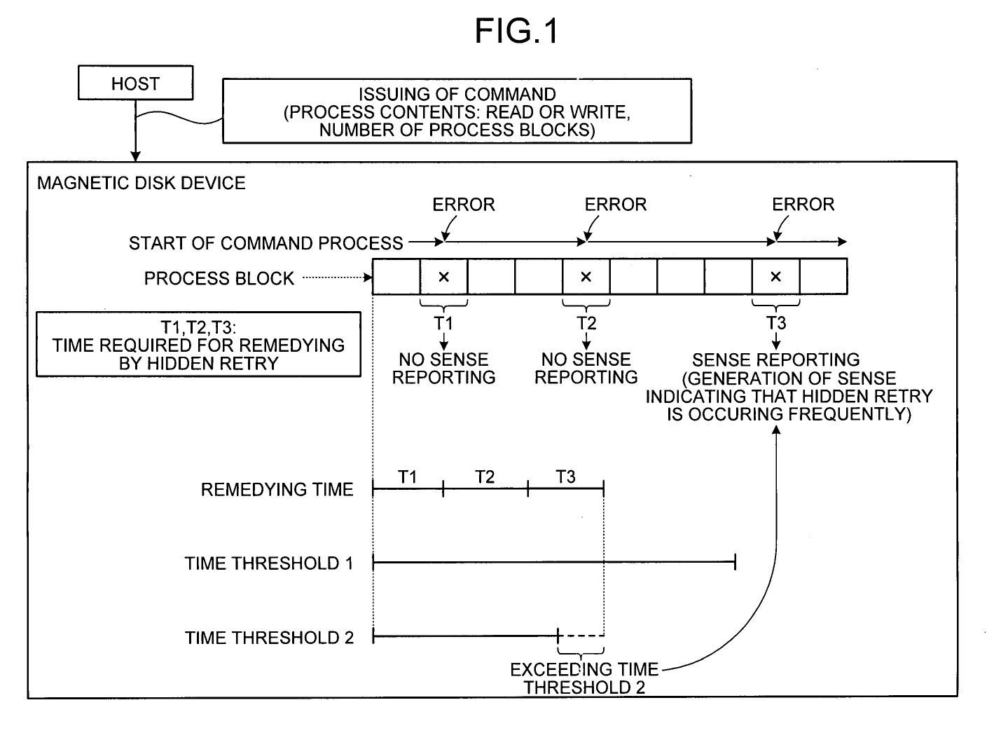

The outline and the salient feature of the magnetic disk device according to the first embodiment are explained with reference to FIG. 1. FIG. 1 is a block diagram of the outline and the salient feature of the magnetic disk device according to the first embodiment. As shown in FIG. 1, the magnetic disk device according to the present embodiment receives a command from a host that is an upper-level device, and carries out a reading process or a writing process. If an error occurs in the reading process or the writing process, the magnetic disk device generates a predetermined sense according to a result of a retry that is executed, and reports the predetermined sense to the upper-level device. Thus, the magnetic disk device according to the first embodiment enables to quickly deal with sectors that are causing a hidden retry to occur frequently and that are likely to cause an unrecoverable error, thereby enabling to prevent occurrence of the unrecoverable error. The aforementioned feature is the salient feature of the magnetic disk device according to the first embodiment.

To specifically explain the salient feature, upon receiving the command that is issued from the host and that includes process content (a reading process or a writing process) and number of process blocks, the magnetic disk device according to the first embodiment starts a command process.

If an error occurs in the reading process or the writing process that is being executed according to the received command, the magnetic disk device starts a retry as the recovery process. In the retry, a retry of a comparatively simple content is carried out a few times and is called the hidden retry, and if the error is not remedied by the hidden retry, a retry of a complex content is immediately carried out several times and is called a normal retry.

The magnetic disk device regulates a time threshold 1 during which attempts of the hidden retry and the normal retry are permitted, and a time threshold 2 for determining whether to carry out sense reporting by a hidden retry attempt time when the error is remedied by the hidden retry. Similarly, the magnetic disk device also regulates a number of attempts that permits attempts of the hidden retry and the normal retry.

In other words, if an error occurs in the reading process or the writing process that is executed according to the command, the magnetic disk device executes the hidden retry and measures the hidden retry attempt time (for example, T1, T2, and T3) that is required for remedying of the error by the hidden retry in the command that is received from the user. Next, for each remedying of the error by the hidden retry in each process block, the magnetic disk device determines whether the hidden retry attempt time is exceeding the time threshold 2. If the hidden retry attempt time is exceeding the time threshold 2, the magnetic disk device generates a sense (a sense to the effect that the hidden retry is occurring frequently) for the command, and reports the generated sense to the host.

Thus, the aforementioned salient feature enables the magnetic disk device according to the first embodiment to quickly deal with the sectors that are causing the hidden retry to occur frequently and that are likely to cause an unrecoverable error, thereby enabling to prevent occurrence of the unrecoverable error.

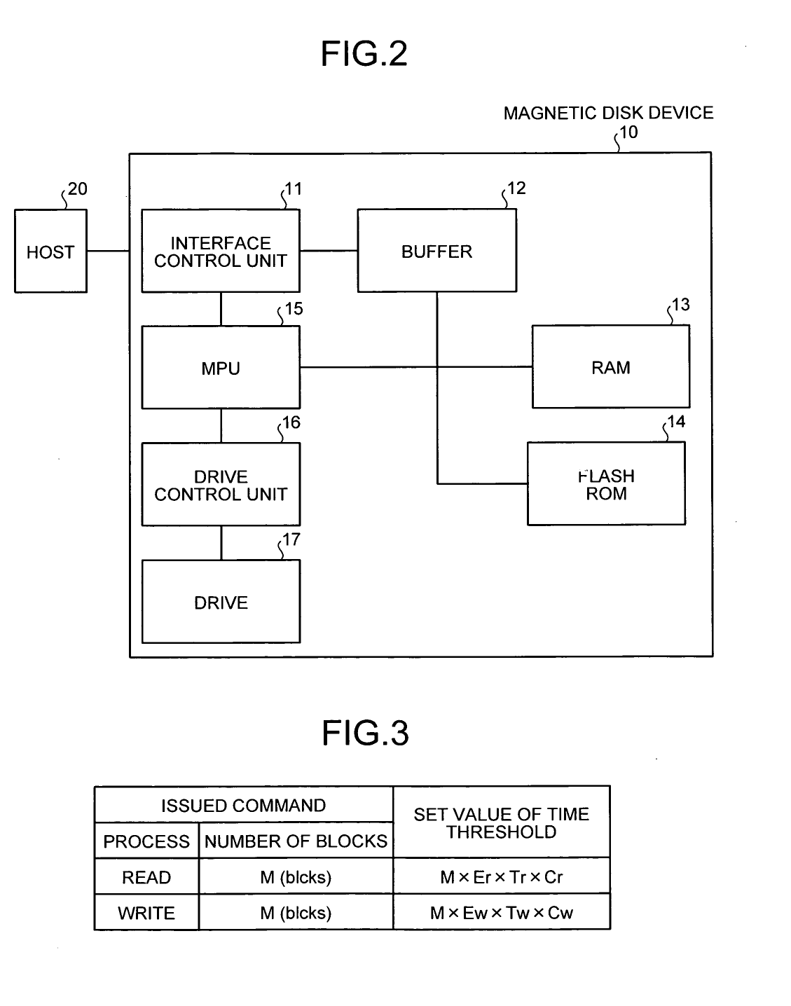

The structure of the magnetic disk device according to the first embodiment is explained next with reference to FIG. 2. FIG. 2 is a block diagram of the structure of the magnetic disk device according to the first embodiment. As shown in FIG. 2, a magnetic disk device 10 is communicably connected to a host 20. The magnetic disk device 10 includes an interface control unit 11, a buffer 12, a Random Access Memory (RAM) 13, a flash Read Only Memory (ROM) 14, a Micro Processor Unit (MPU) 15, a drive control unit 16, and a drive 17.

The interface control unit 11 controls communication related to various types of data that is transacted between the magnetic disk device 10 and the host 20. The buffer 12 temporarily stores data that is received from the host 20 via the interface control unit 11.

The RAM 13 is a storage unit (memory unit) that stores data and programs that are necessary for various processes by the MPU 15. To be specific, the RAM 13 stores the time threshold 1 during which attempts of the hidden retry and the normal retry are permitted, and the time threshold 2 for determining whether to carry out sense reporting by the hidden retry attempt time when the error is remedied by the hidden retry (see FIG. 3). The flash ROM 14 stores data that is received from the buffer 12 etc.

The MPU 15 includes an internal memory for storing predetermined control programs, programs that regulate various process sequences and necessary data that are used by the MPU 15 to execute various processes. To be specific, upon receiving the command issued from the host 20 via the interface control unit 11, as shown in FIG. 3, the MPU 15 automatically calculates the time threshold 2 for each process content (the reading process or the writing process) of the command by multiplying a number of process blocks M, an error occurrence probability per single sector E, an average processing time per single step of the hidden retry T, and an average number of retry attempts C when the error is remedied by the hidden retry. Apart from storing the calculated time threshold 2 in the RAM 13, the MPU 15 issues a command to the drive control unit 16 according to the process content of the received command. The error occurrence probability per single sector E, the average processing time per single step of the hidden retry T, and the average number of retry attempts C when the error is remedied by the hidden retry are prior included as statistical data.

Further, upon execution of the hidden retry by the drive control unit 16, the MPU 15 measures the hidden retry attempt time (for example, T1, T2, and T3) that is required to remedy the error by the hidden retry in the command that is received from the host 20, and determines whether the hidden retry attempt time is exceeding the time threshold 2 for each remedying of the error by the hidden retry in each process block. If the hidden retry attempt time is exceeding the time threshold 2, the MPU 15 generates a sense (a sense to the effect that the hidden retry is occurring frequently) for the command, and reports the generated sense to the host 20 via the interface control unit 11.

The drive control unit 16 receives the command from the MPU 15 and controls the reading process or the writing process in the drive 17. The drive 17 executes the reading process or the writing process on the magnetic disk.

### (Retry Process in a Single Sector (First Embodiment))

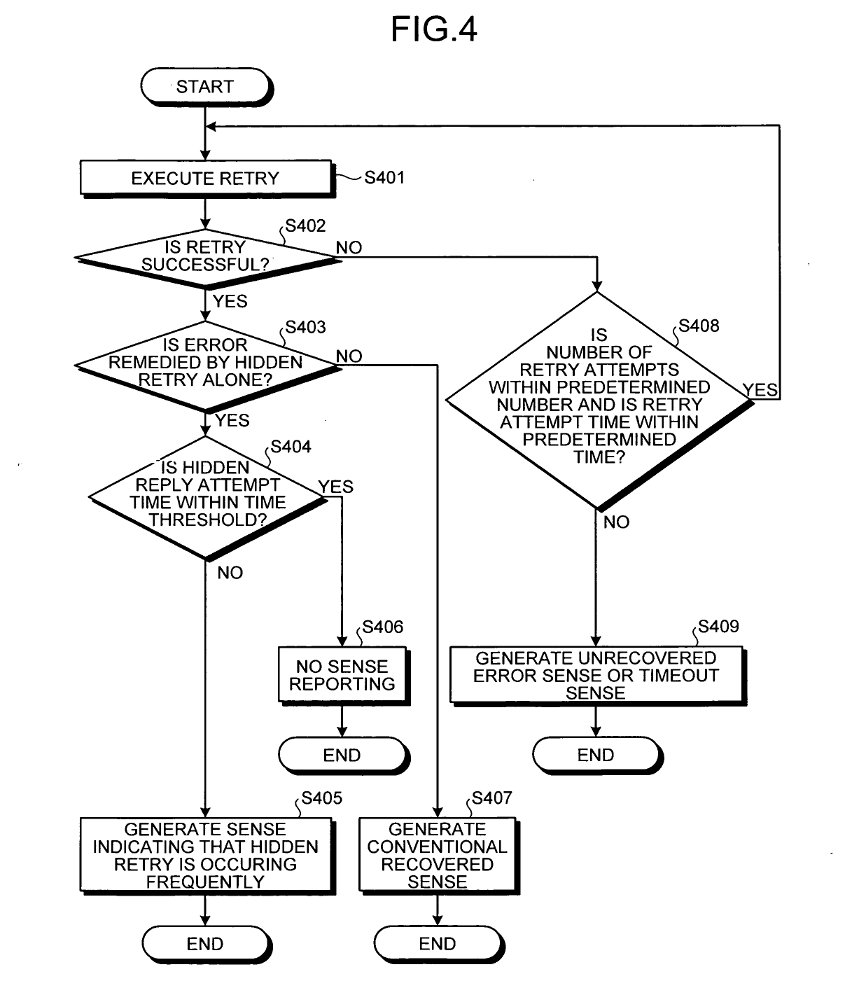

A retry process in a single sector by the magnetic disk device according to the first embodiment is explained next with reference to FIG. 4. FIG. 4 is a flowchart of a sequence of a process of the magnetic disk device according to the first embodiment. As shown in FIG. 4, if an error occurs in the reading process or the writing process that is executed according to the command received from the host 20, the magnetic disk device 10 executes a retry (step S401), and confirms whether the retry is successful (step S402).

If the retry is successful (Yes at step S402), the magnetic disk device 10 further confirms whether the error is remedied only by the hidden retry (step S403). If the error is remedied only by the hidden retry (Yes at step S403), the magnetic disk device 10 determines whether the hidden retry attempt time that is required to remedy the error by the hidden retry in the command received from the host 20 is within the predetermined time threshold (see FIG. 3) (step S404). If the hidden retry attempt time is not within the predetermined time threshold (No at step S404), the magnetic disk device 10 generates a sense indicating a frequent occurrence of the hidden retry (a sense to the effect that the hidden retry is occurring frequently) for the command (step S405), and reports the generated sense to the host 20.

Returning to step S404, if the hidden retry attempt time is within the predetermined time threshold (Yes at step S404), the magnetic disk device 10 does not generate a sense and does not report to the host 20 (step S406). Returning to step S403, if the error is not remedied only by the successful hidden retry (No at step S403), the magnetic disk device 10 generates a conventional recovered sense (for example, a sense to the effect that the error is remedied by the normal retry) (step S407), and reports the generated sense to the host 20.

Returning to step S402, if the retry is not successful (No at step S402), the magnetic disk device 10 confirms whether the number of retry attempts is within the regulated number and whether a retry attempt time is within the regulated time (step S408). If the number of retry attempts is within the regulated number and the retry attempt time is within the regulated time (Yes at step S408), the magnetic disk device 10 executes a retry again (step S401). If the number of retry attempts is exceeding the regulated number or the retry attempt time is exceeding the regulated time (No at step S408), the magnetic disk device 10 generates an unrecovered sense (a sense to the effect that the error is not remedied) or a timeout (a sense to the effect that the error is not remedied within the regulated time) (step S409), and reports the generated unrecovered sense or the timeout to the host 20.

### (Retry Process in Multiple Sectors (First Embodiment))

The retry process in multiple sectors by the magnetic disk device according to the first embodiment is explained next with reference to FIG. 5. FIG. 5 is a flowchart of the sequence of the process of the magnetic disk device according to the first embodiment. As shown in FIG. 5, the magnetic disk device 10 executes the reading process or the writing process according to the command received from the host 20 (step S501), and if an error occurs (Yes at step S502), starts the retry process (step S503). If no error occurs (No at step S502), the magnetic disk device 10 confirms whether the process for the blocks that are within the scope of the command has ended (step S505). If the process for the blocks that are within the scope of the command has not ended (No at step S505), the magnetic disk device 10 executes the reading process or the writing process for the remaining blocks that are within the scope of the command (step S501).

After starting the retry process, the magnetic disk device 10 carries out a process similar to the process that is explained with reference to FIG. 4, generates senses at the predetermined outcomes, and records the generated senses (step S504). To specifically explain a recording process of the senses, the magnetic disk device 10 not only records each sense that is generated during the retry process, but also compares the recorded senses upon completion of the retry process and carries out a process to select a sense of high priority (for example, the unrecovered sense is a sense of higher priority than the sense to the effect that the hidden retry is occurring frequently). Due to this, the sense of high priority is reported to the host 20.

Next, the magnetic disk device 10 confirms whether the process for the blocks that are within the scope of the command has ended (step S505). If the process for the blocks that are within the scope of the command has ended (Yes at step S505), the magnetic disk device 10 ends the command, and if the process for the blocks that are within the scope of the command has not ended (No at step S505), the magnetic disk device 10 executes the reading process or the writing process for the remaining blocks (step S501).

According to the first embodiment, by executing the hidden retry (a retry of a comparatively simple content that is carried out a few times) as a part of the retry, the magnetic disk device 10 measures the remedying time that is required to remedy the error in the command and determines whether the remedying time is exceeding the predetermined time threshold. Thus, if the remedying time required for the hidden retry in the command is exceeding the predetermined time threshold, the magnetic disk device 10 can quickly deal with the sector that is causing the hidden retry to occur frequently and that is likely to cause an unrecoverable error, thereby enabling to prevent occurrence of the unrecoverable error.

Furthermore, according to the first embodiment, upon receiving the command from the host 20, the magnetic disk device 10 sets as the predetermined time threshold a value that is automatically calculated based on a content of the command (the process content and the number of processing blocks), and determines whether the remedying time that is required to remedy the error in the command by the hidden retry is exceeding the time threshold. Thus, the magnetic disk device 10 can set a specific time threshold according to the content of the command (for example, the time threshold 2) and can precisely grasp the frequent occurrence of the hidden retry for the command, thereby enabling to deal quickly with the sector that is likely to cause an unrecoverable error and enabling to prevent occurrence of the unrecoverable error.

Although the first embodiment of the present invention is explained so far, various modifications other than the first embodiment can also be construed. Other embodiments of the present invention are explained below.

According to the first embodiment, if the hidden retry attempt time is exceeding the predetermined time threshold (see FIG. 3), a Self Monitoring Analysis and Reporting Technology (SMART) warning to the effect that the hidden retry is occurring frequently for the command can be issued to the host 20.

Due to this, the host 20 can recognize a performance deterioration of the sectors that are within the scope of the command, thereby enabling to quickly deal with the sectors that are likely to cause an unrecoverable error and enabling to prevent loss of data due to occurrence of the unrecoverable error.

According to the first embodiment, if the hidden retry attempt time is exceeding the predetermined time threshold, the sectors that are within the scope of the command can be automatically switched.

Due to this, the magnetic disk device 10 can quickly degenerate the sectors, which are within the scope of the command and are causing frequent occurrence of the hidden retry, as sectors having high probability of occurrence of an unrecoverable error, thereby enabling to prevent occurrence of the unrecoverable error.

According to the first embodiment, if the hidden retry attempt time is exceeding the predetermined time threshold, a check (Back Ground Media Scan (BGMS)) of whether a reading error has occurred can be carried out for each sector that is within the scope of the command and the sectors in which the reading error has occurred can be automatically switched.

Due to this, among the sectors that are within the scope of the command and are causing frequent occurrence of the hidden retry, the magnetic disk device 10 can quickly and efficiently degenerate the sectors having a high probability of occurrence of an unrecoverable error, thereby enabling to prevent occurrence of the unrecoverable error.

According to the first embodiment, if the hidden retry attempt time is exceeding the predetermined time threshold, the magnetic disk device 10 can also abort the command that is received from the host 20 and that is being executed, and execute another command.

Due to this, the magnetic disk device 10 can abort the command that is causing the hidden retry to occur frequently and that is likely to prolong a process time and can execute the next awaited command, thereby enabling to efficiently carry out the command process while preventing occurrence of the unrecoverable error.

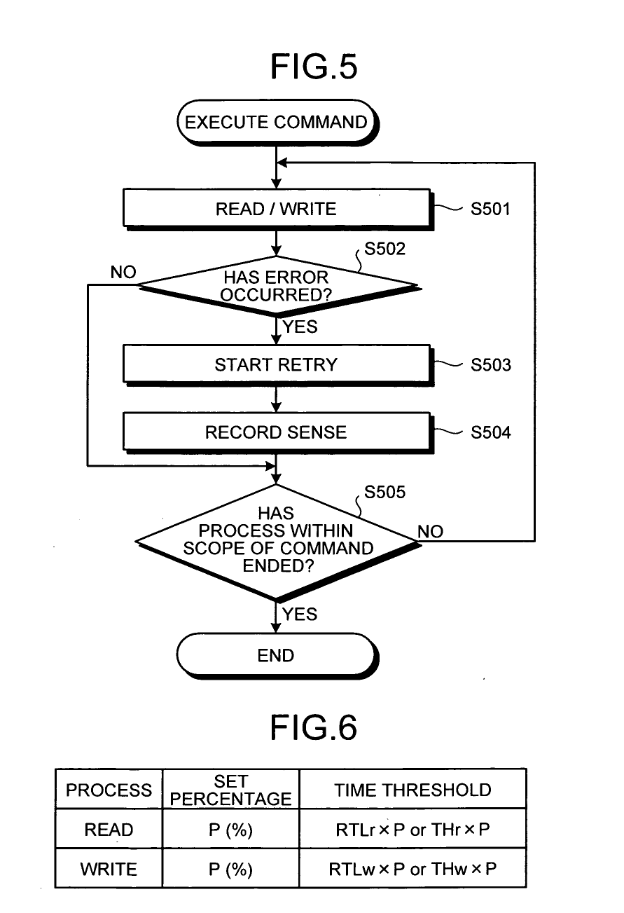

According to the first embodiment, as shown in FIG. 6, a value that is obtained by multiplying a total time for permission of retry attempts (recovery time limit) by a predetermined percentage can be set as the predetermined time threshold, or a value obtained as a result of multiplying by the predetermined percentage the value that is automatically calculated based on the content of the command received from the host 20 (see FIG. 3) can also be set as the predetermined time threshold.

Due to this, the magnetic disk device 10 can use the existing regulated recovery time limit to set the time threshold according to the user or the application. Similarly, the magnetic disk device 10 can use the value that is calculated based on the content of the command and set the time threshold according to the user or the application.

The constituent elements of the magnetic disk device 10 that is shown in FIG. 2 are merely conceptual and may not necessarily physically resemble the structures shown in the drawings. In other words, the magnetic disk device 10 need not necessarily have the structure that is illustrated, and the drive control unit 16 and the drive 17, for example, can be integrated. The magnetic disk device 10 as a whole or in parts can be broken down or integrated either functionally or physically in accordance with the load or how the device is to be used. Further, the process functions performed by the magnetic disk device 10 are entirely or partially realized by the CPU or a program executed by the CPU or by a hardware using wired logic.

All the automatic processes explained in the present embodiment can be, entirely or in part, carried out manually. Similarly, all the manual processes explained in the present embodiment can be entirely or in part carried out automatically by a known method. The sequence of processes, the sequence of controls, specific names, and data including various parameters can be changed as required unless otherwise specified. The present invention is not to be limited to the magnetic disk device, and can be similarly applied to a storage device in the form of an optical disk device such as a Digital Versatile Disk (DVD), a Compact Disk (CD), a Magneto Optic (MO) disk etc.

As described above, according to an embodiment of the present invention, a storage device measures a remedying time that is required to remedy an error in a command by a hidden retry (a retry of a comparatively simple content that is carried out a few times) that is executed as a part of a retry, and determines whether the remedying time is exceeding a predetermined time threshold. Thus, if the time required for the retry in the command is exceeding the predetermined time threshold, the storage device can quickly deal with sectors that are causing the retry to occur frequently and that are likely to cause an unrecoverable error, thereby enabling to prevent occurrence of the unrecoverable error.

Furthermore, according to an embodiment of the present invention, if the remedying time that is required to remedy the error in the command by the hidden retry is exceeding the predetermined time threshold, the storage device issues to the upper-level device (for example, a host that issues commands to a magnetic disk device etc.) a warning to the effect that the hidden retry is occurring frequently for the command. Thus, due to issue of the warning to the effect that the hidden retry is occurring frequently for the command, the host can recognize a performance degradation in the sectors that are within the scope of the command, thereby enabling the host to quickly deal with the sectors that are likely to cause an unrecoverable error and enabling to prevent occurrence of the unrecoverable error.

Moreover, according to an embodiment of the present invention, upon receiving the command from the upper-level device, a value that is automatically calculated based on a content of the command (process content and a number of process blocks) is set as the predetermined time threshold, and the storage device determines whether the remedying time that is required to remedy the error in the command by the hidden retry is exceeding the set predetermined time threshold. Thus, the storage device can set a specific time threshold according to the content of the command and can precisely grasp frequent occurrence of the retry for the command, thereby enabling to quickly deal with the sectors that are likely to cause an unrecoverable error and enabling to prevent occurrence of the unrecoverable error.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A storage device that performs a reading process or a writing process based on a command received from an upper-level device, and when an error occurs in the reading process or the writing process, generates a predetermined sense according to a result of a retry, and reports the predetermined sense to the upper-level device, the storage device comprising:
a time measuring unit that measures a remedying time that is required to remedy the error in execution of the command by a hidden retry that is executed as a sort of the retry; and
a time determining unit that determines whether the remedying time measured by the time measuring unit exceeds a predetermined time threshold.

2. The storage device according to claim 1, further comprising:
a warning unit that performs, when the time determining unit determined that the remedying time exceeds the predetermined time threshold, a warning indicating that the hidden retry is occurring frequently for the command, to the upper-level device.

3. The storage device according to claim 1, further comprising:
a sector switching unit that automatically switches, when the time determining unit determined that the remedying time exceeds the predetermined time threshold, a sector within a request range of the command.

4. The storage device according to claim 3, further comprising:
a checking unit that checks, when the time determining unit determined that the remedying time exceeds the predetermined time threshold, whether a reading error occurs, for each sector within the request range of the command, wherein
the sector switching unit automatically switches the sector that is checked by the checking unit and determined to have the reading error.

5. The storage device according to claim 1, further comprising:
a command control unit that aborts, when the time determining unit determined that the remedying time exceeds the predetermined time threshold, the command that is received from the upper-level device and that is being executed, and executes other command.

6. The storage device according to claim 1, further comprising:
a threshold setting unit that calculates automatically, when the command is received from the upper-level device, a first value based on a content of the command, and sets the calculated first value as the predetermined time threshold, wherein
the time determining unit determines whether the remedying time exceeds the predetermined time threshold set by the threshold setting unit.

7. The storage device according to claim 6, wherein
the threshold setting unit sets a second value that is obtained by multiplying a total time for which an attempt of the retry is permitted by a predetermined proportion, as the predetermined time threshold.

8. The storage device according to claim 6, wherein
the threshold setting unit sets a second value that is obtained by multiplying the first value by a predetermined proportion, as the predetermined time threshold.

9. A control device for a storage device that performs a reading process or a writing process based on a command received from an upper-level device, and when an error occurs in the reading process or the writing process, generates a predetermined sense according to a result of a retry, and reports the predetermined sense to the upper-level device, the control device comprising:
a time measuring unit that measures a remedying time that is required to remedy the error in execution of the command by a hidden retry that is executed as a sort of the retry; and
a time determining unit that determines whether the remedying time measured by the time measuring unit exceeds a predetermined time threshold.

10. The control device according to claim 9, further comprising:
a warning unit that performs, when the time determining unit determined that the remedying time exceeds the predetermined time threshold, a warning indicating that the hidden retry is occurring frequently for the command, to the upper-level device.

11. The control device according to claim 9, further comprising:
a sector switching unit that automatically switches, when the time determining unit determined that the remedying time exceeds the predetermined time threshold, a sector within a request range of the command.

12. The control device according to claim 11, further comprising:
a checking unit that checks, when the time determining unit determined that the remedying time exceeds the predetermined time threshold, whether a reading error occurs, for each sector within the request range of the command, wherein
the sector switching unit automatically switches the sector that is checked by the checking unit and determined to have the reading error.

13. The control device according to claim 9, further comprising:
a command control unit that aborts, when the time determining unit determined that the remedying time exceeds the predetermined time threshold, the command that is received from the upper-level device and that is being executed, and executes other command.

14. The control device according to claim 9, further comprising:
a threshold setting unit that calculates automatically, when the command is received from the upper-level device, a first value based on a content of the command, and sets the calculated first value as the predetermined time threshold, wherein
the time determining unit determines whether the remedying time exceeds the predetermined time threshold set by the threshold setting unit.

15. The control device according to claim 14, wherein
the threshold setting unit sets a second value that is obtained by multiplying a total time for which an attempt of the retry is permitted by a predetermined proportion, as the predetermined time threshold.

16. The control device according to claim 14, wherein
the threshold setting unit sets a second value that is obtained by multiplying the first value by a predetermined proportion, as the predetermined time threshold.

17. An error reporting method for a storage device that performs a reading process or a writing process based on a command received from an upper-level device, and when an error occurs in the reading process or the writing process, generates a predetermined sense according to a result of a retry, and reports the predetermined sense to the upper-level device, the error reporting method comprising:
measuring a remedying time that is required to remedy the error in execution of the command by a hidden retry that is executed as a sort of the retry; and
determining whether the remedying time measured by the time measuring unit exceeds a predetermined time threshold.
